(19) United States
(12) Patent Application Publication
(10) Pub. No.: US 2006/0227403 A1
(43) Pub. Date: Oct. 12, 2006

(54) LASER SCAN UNIT HAVING THERMALLY-TRANSFORMABLE SLIT

(76) Inventors: Wook-bae Kim, Suwon-si (KR); Dae-hwan Kim, Suwon-si (KR)

Correspondence Address: STANZIONE & KIM, LLP, 919 18TH STREET, N.W., SUITE 440, WASHINGTON, DC, 20006, US

(21) Appl. No.: 11/277,666

(22) Filed: Mar. 28, 2006

(30) Foreign Application Priority Data
Apr. 12, 2005 (KR) 2005-30153

(51) Int. Cl. G02F 1/01

(52) U.S. Cl. 359/288

(57) ABSTRACT

A laser scan unit includes a thermally-transformable slit having a laser beam hole that is variable in size to control a laser spot size being projected from a light source and focused on a scanning objective according to change of temperature. The thermally-transformable slit reduces the laser beam hole when the temperature increases and enlarges the laser beam hole when the temperature decreases. Additionally, the thermally-transformable slit includes a slit member having the laser beam hole, and a thermally-transformable member disposed near the laser beam hole of the slit member and transformable according to the temperature to partly block the laser beam hole, thereby controlling the size of the laser beam hole.

### CROSS-REFERENCE TO RELATED APPLICATIONS

This application claims benefit under 35 U.S.C. § 119(a) of Korean Patent Application No. 2005-30153, filed Apr. 12, 2005, the entire contents of which are incorporated herein by reference.

### BACKGROUND OF THE INVENTION

1. Field of the Invention

The present general inventive concept relates to an electrophotographic image forming apparatus. More particularly, the present general inventive concept relates to a laser scan unit that forms an electrostatic latent image by irradiating a laser beam onto a photoconductive medium.

2. Description of the Related Art

An electrophotographic image forming apparatus, such as a laser beam printer, comprises a light projector irradiating a light corresponding to information on a desired image, and a photoconductive medium carrying an electrostatic latent image formed by the light irradiated from the light projector. For the light projector, a laser scan unit is generally used, which generates a laser beam and forms an image from the laser beam on the photoconductive medium.

In general, an electrophotographic laser beam printer is defined by a spot size of the laser beam projected from the laser scan unit and formed on the photoconductive medium. Recently, an improved laser beam printer has been introduced that varies the laser spot size, which enables conversion among a plurality of differently-defined electrophotographic laser printers.

FIG. 1 schematically illustrates a laser scan unit applied for the definition-convertible laser beam printer, i.e., that is capable of varying the laser spot size, as disclosed in Japanese Patent Laid-open No. 9-230367.

In FIG. 1, a reference numeral 1 denotes a laser diode as a light source, 2 denotes a collimating lens, 3 denotes a cylinder lens, and 4 and 5 respectively denote first and second slits for controlling luminosity and the laser spot size. As illustrated in FIG. 1, the first and the second slits 4 and 5 are disposed between the collimating lens 2 and the cylinder lens 3. The second silt 5 is connected to a slit controller 6.

The first slit 4 determines the laser spot size in horizontal scanning. The second slit 5, being formed of a slit member having a two-step width, determines the laser spot size in vertical scanning by two steps. Thus, since the laser spot size in vertical scanning is variable through two steps, thereby controlling the laser spot size formed on the surface of photoconductive medium by two steps, dot per inch (dpi) and line width can be adjusted as desired.

The laser scan unit disclosed in Japanese Patent Laid-open No. 9-159960 includes a slit in which the width can be linearly varied in order to control the dpi and the line width, a slit controller driver which electronically controls motion of the slit, a mechanical part, and a circuit which compensates changes in optical output according to the varied slit. In this laser scan unit, the change of the laser spot size according to the varied slit width is stored to a memory and the slit controller is operated by the slit controller driver and a motor using the stored information when the dpi is changed, thereby controlling the laser spot size.

In the conventional laser scan units as described above, however, the dedicated mechanical part for varying the dpi by controlling the laser spot size formed on the photoconductive drum, the electronic driver, and the circuit complicate the structure of the laser scan unit and increase the manufacturing cost.

In addition, conventional laser scan units generally employs a square slit as a laser beam hole. However, since a circular or oval hole is preferable for image formation, the square slit may degrade printing quality.

Furthermore, fast printing is highly desired. Nevertheless, when the laser scan unit cannot adapt to a laser spot size that is changeable according to change of an inner temperature of the laser scan unit, it is hard to maintain desired printing quality when printing for long periods of time.

### SUMMARY OF THE INVENTION

The present general inventive concept provides a laser scan unit capable of simplifying the structure and reducing the manufacturing cost thereof by adopting a thermally-transformable slit operated by a simple mechanism.

The present general inventive concept also provides a laser scan unit having a thermally-transformable slit capable of forming an optimum focus on an image forming surface by adopting the slit having a circular or oval laser beam hole which is variable in size.

The present general inventive concept also provides a laser scan unit having a thermally-transformable slit capable of automatically controlling a laser spot size according to change of temperature, thereby maintaining regular image quality.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a laser scan unit includes a thermally-transformable slit having a laser beam hole that is variable in size to control a laser spot size projected from a light source and focused on a scanning objective according to a change in temperature.

The thermally-transformable slit may include a slit member having the laser beam hole, and a thermally-transformable member disposed near the laser beam hole of the slit member and transformable according to the change in temperature to partly block the laser beam hole to control the size of the laser beam hole.

The thermally-transformable member may further include a pair of legs disposed at opposite sides of the laser beam hole, the legs being moveable inward and outward with respect to a fixing pin to stepwise reduce and enlarge the size of the laser beam hole.

The laser beam hole may be substantially circular or oval.

The thermally-transformable slit may include first and second slit members each having a laser beam hole that overlap one another, and each being moveable so that an amount of overlap the overlapped laser beam holes can be varied, and a thermally-transformable member disposed between the first and the second slit members to move the first and the second slit members and transformable according to the change in temperature.

The thermally-transformable member may include a bimetal or a bio-metal. The thermally-transformable member may comprise a pair of legs respectively fixed to first and second fixing points of the first and the second slit members, the legs being moveable inward and outward with respect to a third fixing point to move the first and the second slit members.

The foregoing and/or other aspects and utilities of the present general inventive concept may also be achieved by providing a laser scan unit including a light source to project a laser beam, a collimating lens to covert the laser beam projected from the light source to a parallel beam, a thermally-transformable slit having a laser beam hole that is variable in size according to a change in temperature to control a shape and a size of the laser beam passed through the collimating lens to vary a laser spot size according to the change in temperature, a cylinder lens to covert the laser beam passed through the thermally-transformable slit to a linear beam in a horizontal direction with respect to a vertical scanning direction, a polygon mirror assembly to scan by moving the horizontal linear beam passed through the cylinder lens at a constant linear velocity, and a scanning lens to polarize the linear beam passed through the polygon mirror in a horizontal scanning direction to compensate for a spherical aberration, and to focus the linear beam on a surface being scanned.

The foregoing and/or other aspects and utilities of the present general inventive concept may also be achieved by providing a laser scan unit, including a light source, a collimating lens, a cylinder lens, and a thermally-transformable slit transformable according to a change in a temperature of the laser scan unit to modify a depth of field of the laser scan unit, the thermally-transformable slit being located between the collimating lens and the cylinder lens. The thermally-transformable slit may include at least one slit member, at least one laser beam hole, a thermally-transformable member, a pair of legs, and a fixing pin hole. The at least one laser beam hole may have a shape that changes according to the change in the temperature of the laser scan unit. The at least one laser beam hole may have a size that changes according to the change in the temperature of the laser scan unit. The shape of the at least one laser beam hole may be a non-square shape. The shape of the at least one laser beam hole may be a substantially-circular shape or a substantially-oval shape. The laser scan unit may further include a polygon mirror assembly, a scanning lens unit, a reflection mirror, a horizontal synchronization mirror, and an optical sensor.

The foregoing and/or other aspects and utilities of the present general inventive concept may also be achieved by providing an electrophotographic image forming apparatus, including a light projector including the laser scan unit and a photoconductive medium.

The foregoing and/or other aspects and utilities of the present general inventive concept may also be achieved by providing a method of irradiating a laser beam onto a photoconductive medium using a laser scan unit, the method including projecting a laser beam, converting the projected laser beam to a parallel beam, controlling a size of the parallel beam and a depth of field of the laser scan unit using a thermally-transformable slit comprising a beam hole, and converting the controlled parallel beam into a linear beam. The controlling the size of the parallel beam and the depth of field of the laser scan unit may include partially blocking the beam hole of the thermally-transformable slit to increase the depth of field of the laser scan unit. The controlling the size of the parallel beam and the depth of field of the laser scan unit may include decreasing or increasing a diameter of the beam hole of the thermally-transformable slit to correspondingly increase or decrease the depth of field of the laser scan unit. The controlling the size of the parallel beam and the depth of field of the laser scan unit may include decreasing the size of the beam hole by narrowing the hole or by partially blocking the hole to increase the depth of field of the laser scan unit in response to an increase in a temperature of the laser scan unit. The method may further include moving the linear beam at a constant velocity, polarizing the constant velocity linear beam, and vertically reflecting the beam to form a dotted image on a surface of a photoconductive medium. The method may further include compensating for a spherical aberration before polarizing the constant velocity linear beam. The polarizing of the constant velocity linear beam may include polarizing the beam to the vertical scanning direction by a predetermined refractive index.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 schematically illustrates a prior art laser scan unit;

FIG. 2 schematically illustrates a laser scan unit having a thermally-transformable slit according to a first embodiment of the present general inventive concept;

FIG. 3 schematically illustrates an operation principle of the thermally-transformable slit illustrated in FIG. 2;

FIGS. 4A and 4B are a front view and a side view, respectively, illustrating a structure and an operation of the thermally-transformable slit illustrated in FIG. 2; and

FIG. 5 illustrates a thermally-transformable slit according to a second embodiment of the present general inventive concept.

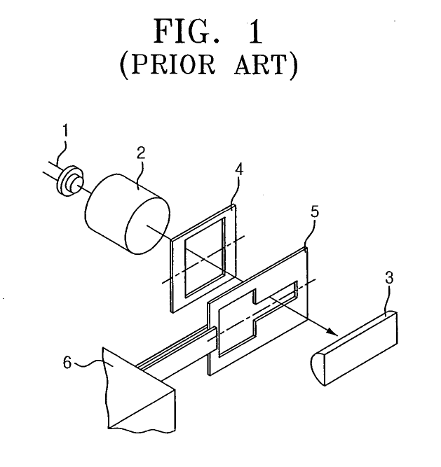

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the following description, the matters defined in the description such as a detailed construction and elements are nothing but the ones provided to assist in a comprehensive understanding of the general inventive concept. Thus, it is apparent that the present general inventive concept can be carried out without those defined matters.

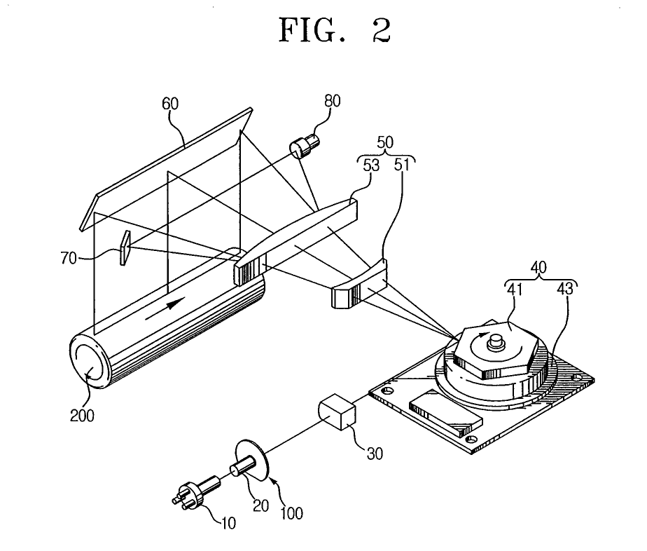

As illustrated in FIG. 2, a laser scan unit according to an embodiment of the present general inventive concept, includes a laser diode 10 as a light source, a collimating lens 20, a cylinder lens 30, a thermally-transformable slit 100 disposed between the collimating lens 20 and the cylinder lens 30, a polygon mirror assembly 40, an f·θ lens 50 (hereinafter, referred to as ‘scanning lens’), a reflection mirror 60, a horizontal synchronization mirror 70 and an optical sensor 80.

The laser diode 10 generates and projects a laser beam according to a video signal of an input image. The collimating lens 20 converts the laser beam projected from the laser diode 10 to a parallel beam with respect to a beam axis. The cylinder lens 30 converts the parallel beam passed through the collimating lens 20 to a linear beam horizontal to a vertical scanning direction. The polygon mirror assembly 40 performs scanning by moving the linear beam passed through the cylinder lens 30 at a constant linear velocity. The polygon mirror assembly 40 includes a polygon mirror 41 having a plurality of specular surfaces and a polygon mirror driver 43.

The scanning lens 50 polarizes the beam of the constant linear velocity, passed through the polygon mirror 41 to the vertical scanning direction and compensates for a spherical aberration to focus the beam on a scanning surface. To this end, the scanning lens 50 includes a spherical lens 51 to compensate for the spherical aberration and a toric lens 53 polarizing the compensated laser beam to the vertical scanning direction by a predetermined refractive index. The reflection mirror 60 vertically reflects the laser beam passed through the scanning lens 50 to thereby form a dotted image on a surface of a photoconductive medium 200, that is, an image forming surface. The horizontal synchronization mirror 70 horizontally reflects the laser beam passed through the scanning lens 50. The optical sensor 80 receives and synchronizes the laser beam reflected from the horizontal synchronization mirror 70.

The thermally-transformable slit 100 controls shape and size of the laser beam passed through the collimating lens 20, for example, luminosity and a laser spot size. The thermally-transformable slit 100 may include a laser beam hole that is variable in size according to an inner temperature of the laser scan unit, or to an ambient temperature, so that the laser spot size can be controlled according to the temperature.

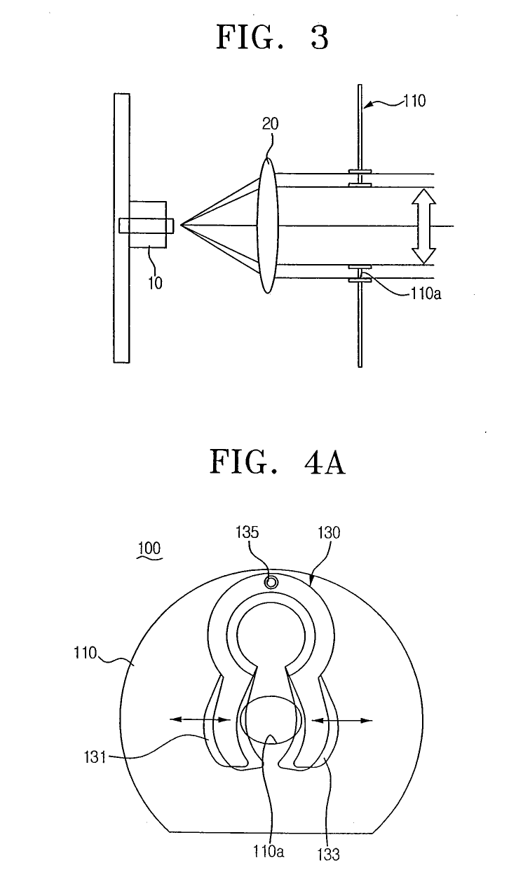

As illustrated in FIGS. 3, 4A and 4B, the thermally-transformable slit 100 according to an embodiment of the present general inventive concept includes a slit member 110 having the laser beam hole 110a, and a thermally-transformable member 130 disposed near the laser beam hole 110a of the slit member 110. The thermally-transformable member 130 is transformed as the temperature changes, thereby controlling the size of the laser beam hole 110a by partly blocking the laser beam hole 110a. More specifically, the thermally-transformable slit 100 reduces the laser beam hole 110a when the inner temperature of the laser scan unit increases, and enlarges the laser beam hole 110a when the inner temperature decreases.

In the laser scan unit, the laser spot size formed on the photoconductive medium, a depth of field, and the luminosity are changed according to variation of the size of the laser beam hole 110a. Since the size of the printed dots is determined by the laser spot size on the photoconductive medium, it can be understood that the slit defines a printer. A relationship between the size of the laser beam hole 110a and the image forming laser spot size can be expressed by [Expression 1] as follows:

$$d ∝ \frac{λ f}{D} \qquad [ Expression 1 ]$$

wherein, ‘d’ denotes the laser spot size, ‘D’ denotes a diameter of the laser beam hole of the slit, and ‘λ’ denotes a wavelength.

Meanwhile, a numerical aperture (NA) is changed according to the size of the laser beam hole 110a. The NA decreases by reducing the laser beam hole, thereby increasing the depth of field. When the laser scan unit has a high depth of field, printing quality can be stable because as the inner temperature of the laser scan unit increases, frames, optical parts and optical supporting parts may be transformed and deviated from their initial positions so that the laser spot size on the image forming surface varies. Accordingly, in order to cope with the increase of the inner temperature, it is preferable that the laser scan unit has the high depth of field.

When the temperature of the laser scan unit increases, if the size of the laser beam hole 110a of the thermally-transformable slit 100 is reduced, the laser spot size and the depth of field each increase. While such an increase of the laser spot size does not highly influence the printing quality, deflection of an optical path due to the increase of temperature deteriorates operation of a printer and the image quality. In particular, when minor errors are generated during assembling of the respective parts by the increase in temperature, printing quality is considerably influenced. However, a conventional slit cannot control the depth of field and therefore cannot cope with the increase in temperature.

Since the thermally-transformable slit 100 according to an embodiment of the present general inventive concept is provided with the thermally-transformable member 130 (which transforms according to the temperature of the slit member 110 having the laser beam hole 110a), when the inner temperature of the laser scan unit increases, the laser beam hole 110a is partly blocked by the thermally-transformable member 130, thereby increasing the depth of field. As a result, printing quality can be maintained or improved even though the printer is used for a long period of time, resulting in the increase in temperature.

As illustrated in FIGS. 4A and 4B, the thermally-transformable member 130 can include a pair of legs 131 and 133 disposed on each side of the laser beam hole 110a of the slit member 110. Additionally, the thermally-transformable member 130 can be fixed to a center portion of the slit member 110 by a fixing pin 135. Therefore, as the legs 131 and 133 transform in arrowed directions with respect to the fixing pin 135, the thermally-transformable member 130 can control the size of the laser beam hole 110a.

The laser beam hole 110a may have a substantially circular form as illustrated in FIGS. 4A and 4B. In an initial position, the pair of legs 131 and 133 do not block the laser beam hole 110a. However, as the inner temperature increases, the pair of legs 131 and 133 are transformed inwardly with respect to the fixing pin 135 (i.e., towards each other), thereby partly blocking and reducing the size of the laser beam hole 110a. When the temperature is lowered and recovered, the legs 131 and 133 return to the initial position (i.e., are transformed outwardly, away from each other), thereby enlarging and restoring the size of the laser beam hole 110a.

The thermally-transformable member 130 may be a bimetal comprising two different metals having different thermal expansion coefficients and attached to each other, or may be a bio-metal, that anisotropically expands and contracts according to the temperature. However, the present general inventive concept is not limited to such a bimetal and/or bio-metal, and thus may adopt any other metal or material that thermally expands and contracts. Also, the laser beam hole 110a of the slit member 110 may have forms other than a substantially circular form, such as an oval form.

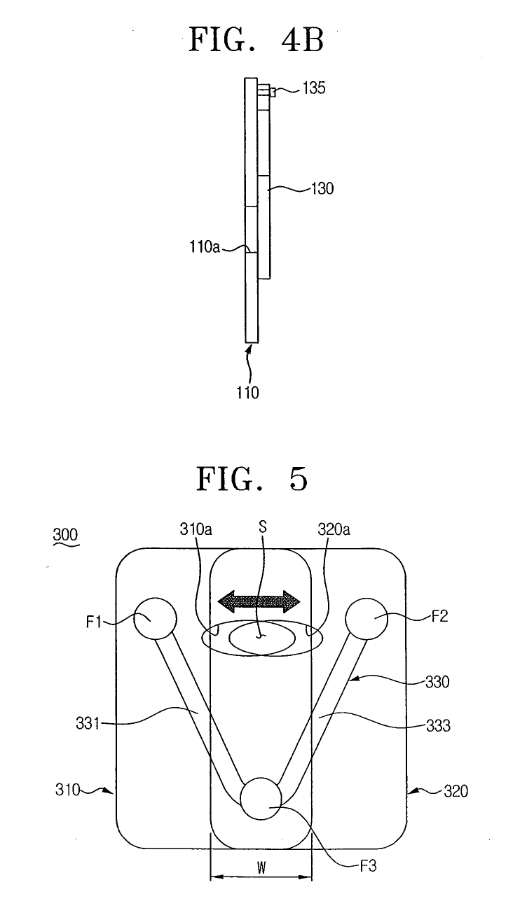

FIG. 5 schematically illustrates a thermally-transformable slit 300 of a laser scan unit according to another embodiment of the present general inventive concept.

This embodiment is similar to the previous embodiment. However, the thermally-transformable slit 300 in this embodiment can include first and second slit members 310 and 320 respectively having laser beam holes 310a and 320a, and a thermally-transformable member 330.

The first and the second slit members 310 and 320 can be arranged so that the laser beam holes 310a and 320a overlap and are configured to be movable in arrowed directions in FIG. 5 so that a space S formed by the overlapping laser beam holes 310a and 320a can vary in size.

The thermally-transformable member 330 can include a pair of legs 331 and 333 each having an end respectively fixed to the first and the second slit members 310 and 320. Here, the fixing points of the first and the second slit members 310 and 320 are denoted in FIG. 5 by F1 and F2, respectively. The pair of legs 331 and 333 transform inward or outward with respect to another fixing point F3 as the temperature changes. Accordingly, an overlapping width W of the first and the second slit members 310 and 320 is changed, thereby varying the size of the space S.

In the present embodiment, function, material and operation of the thermally-transformable member 330 are not different from those of the thermally-transformable member 130 in the previous embodiment. Also, the thermally-transformable slit 300 has the same effect as the previous embodiment.

However, according to the embodiment as illustrated in FIGS. 4A and 4B, since the size of the laser beam hole 110a is controlled in only one direction, the laser spot size and the depth of field can be controlled in only one direction of the vertical scanning or the horizontal scanning directions. On the other hand, according to the embodiment as illustrated in FIG. 5, the size of the overlapped laser beam hole can be controlled in both directions of the vertical scanning and the horizontal scanning directions, according to an overlapped degree of the two laser beam holes 310a and 320a in an oval form (i.e., the amount of overlap between the two laser beam holes 310a and 320a). Therefore, in the embodiment of FIG. 5, the laser spot size and the depth of field in both directions can be controlled.

As can be appreciated from the above description of the embodiments of the present general inventive concept, although an inner temperature of a laser scan unit increases, a depth of field of an optical system can be high, thereby ensuring regular printing quality.

In addition, since laser scan units according to embodiments of the present general inventive concept include a thermally-transformable slit operated by a simple mechanism, the laser scan unit's structure can be simplified and manufacturing costs can therefore be decreased.

Furthermore, the laser scan units according to embodiments of the present general inventive concept include a slit having, for example, circular or oval laser beam holes. A laser beam can be focused on an image forming surface in a desirable manner, thereby preventing deterioration of printing quality caused by a shape of the laser beam hole.

While the general inventive concept has been illustrated and described with reference to certain embodiments thereof, it will be understood by those skilled in the art that various changes in form and details may be made therein without departing from the spirit and scope of the general inventive concept as defined by the appended claims.

What is claimed is:

1. A laser scan unit comprising:
a light source to generate a laser beam;
a scanning device to form an image by irradiating the laser beam projected from the light source; and
a thermally-transformable slit having a laser beam hole that is variable in size to control a laser spot size focused on a scanning objective according to a change in temperature.

2. The laser scan unit of claim 1, wherein the thermally-transformable slit reduces a size of the laser beam hole when the temperature increases and enlarges the size of the laser beam hole when the temperature decreases.

3. The laser scan unit of claim 2, wherein the thermally-transformable slit comprises:
a slit member having the laser beam hole; and
a thermally-transformable member disposed near the laser beam hole of the slit member and transformable according to the change in temperature to partly block the laser beam hole to control the size of the laser beam hole.

4. The laser scan unit of claim 3, wherein the thermally-transformable member comprises a bimetal.

5. The laser scan unit of claim 3, wherein the thermally-transformable member comprises a bio-metal.

6. The laser scan unit of claim 3, wherein the thermally-transformable member comprises a pair of legs disposed at opposite sides of the laser beam hole, the legs being moveable inward and outward with respect to a fixing pin to stepwise reduce and enlarge the size of the laser beam hole.

7. The laser scan unit of claim 6, wherein the laser beam hole has a substantially circular shape.

8. The laser scan unit of claim 2, wherein the thermally-transformable slit comprises:
first and second slit members each having a laser beam hole that overlap one another, and each being moveable so that an amount of overlap of the overlapped laser beam holes can be varied; and
a thermally-transformable member disposed between the first and the second slit members to move the first and the second slit members and transformable according to the change in temperature.

9. The laser scan unit of claim 8, wherein the thermally-transformable member comprises a bimetal.

10. The laser scan unit of claim 8, wherein the thermally-transformable member comprises a bio-metal.

11. The laser scan unit of claim 9, wherein the thermally-transformable member comprises a pair of legs respectively fixed to first and second fixing points of the first and the second slit members, the legs being moveable inward and outward with respect to a third fixing point to move the first and the second slit members.

12. The laser scan unit of claim 11, wherein the laser beam hole has a substantially oval shape.

13. A laser scan unit comprising:
a light source to project a laser beam;
a collimating lens to convert the laser beam projected from the light source to a parallel beam;
a thermally-transformable slit having a laser beam hole that is variable in size according to a change in temperature to control a shape and a size of the laser beam passed through the collimating lens to vary a laser spot size according to the change in temperature;
a cylinder lens to covert the laser beam passed through the thermally-transformable slit to a linear beam in a horizontal direction with respect to a vertical scanning direction;
a polygon mirror assembly to scan by moving the horizontal linear beam passed through the cylinder lens at a constant linear velocity; and
a scanning lens to polarize the linear beam passed through the polygon mirror in a horizontal scanning direction, to compensate for a spherical aberration, and to focus the linear beam on a surface being scanned.

14. The laser scan unit of claim 13, wherein the thermally-transformable slit reduces the laser beam hole when the temperature increases and enlarges the laser beam hole when the temperature decreases.

15. The laser scan unit of claim 14, wherein the thermally-transformable slit comprises:
a slit member having the laser beam hole having a substantially circular shape; and
a thermally-transformable member disposed near the laser beam hole of the slit member and transformable according to the change in temperature to partly block the laser beam hole, to control the size of the laser beam hole.

16. The laser scan unit of claim 15, wherein the thermally-transformable member comprises a bimetal.

17. The laser scan unit of claim 16, wherein the thermally-transformable member comprises a pair of legs disposed at opposite sides of the laser beam hole, the legs being moveable inward and outward with respect to a fixing pin to stepwise reduce and enlarge the size of the laser beam hole.

18. The laser scan unit of claim 14, wherein the thermally-transformable slit comprises:
first and second slit members each having an oval laser beam hole that overlap one another, and movably arranged so that the overlapped laser beam holes can be varied; and
a thermally-transformable member disposed between the first and the second slit members to move the first and the second slit members and transformable according to the change in temperature.

19. The laser scan unit of claim 18, wherein the thermally-transformable member comprises a bimetal.

20. The laser scan unit of claim 19, wherein the thermally-transformable member comprises a pair of legs respectively fixed to first and second fixing points of the first and the second slit members, the legs being moveable inward and outward with respect to a third fixing point to move the first and the second slit members.

21. A laser scan unit, comprising:
a light source;
a collimating lens;
a cylinder lens; and
a thermally-transformable slit transformable according to a change in a temperature of the laser scan unit to modify a depth of field of the laser scan unit, the thermally-transformable slit being located between the collimating lens and the cylinder lens.

22. The laser scan unit of claim 21,
wherein the thermally-transformable slit comprises at least one slit member, at least one laser beam hole, a thermally-transformable member, a pair of legs, and a fixing pin hole.

23. The laser scan unit of claim 22,
wherein the at least one laser beam hole has a shape that changes according to the change in the temperature of the laser scan unit.

24. The laser scan unit of claim 22, wherein the at least one laser beam hole has a size that changes according to the change in the temperature of the laser scan unit.

25. The laser scan unit of claim 22,
wherein a shape of the at least one laser beam hole is a non-square shape.

26. The laser scan unit of claim 22,
wherein a shape of the at least one laser beam hole is a substantially-circular shape or a substantially-oval shape.

27. The laser scan unit of claim 21, further comprising:
a polygon mirror assembly;
a scanning lens unit;
a reflection mirror;
a horizontal synchronization mirror; and
an optical sensor.

28. An electrophotographic image forming apparatus, comprising:
a light projector comprising the laser scan unit of claim 21; and
a photoconductive medium.

29. A method of irradiating a laser beam onto a photoconductive medium using a laser scan unit, the method comprising:
projecting a laser beam;
converting the projected laser beam to a parallel beam;
controlling a size of the parallel beam and a depth of field of the laser scan unit using a thermally-transformable slit comprising a beam hole; and
converting the controlled parallel beam into a linear beam.

30. The method of claim 29, wherein the controlling the size of the parallel beam and the depth of field of the laser scan unit comprises partially blocking the beam hole of the thermally-transformable slit to increase the depth of field of the laser scan unit.

31. The method of claim 29, wherein the controlling the size of the parallel beam and the depth of field of the laser scan unit comprises decreasing or increasing a diameter of the beam hole of the thermally-transformable slit to correspondingly increase or decrease the depth of field of the laser scan unit.

32. The method of claim 29, wherein the controlling the size of the parallel beam and the depth of field of the laser scan unit comprises decreasing the size of the beam hole by narrowing the hole or by partially blocking the hole to increase the depth of field of the laser scan unit in response to an increase in a temperature of the laser scan unit.

33. The method of claim 29, further comprising:
moving the linear beam at a constant velocity;
polarizing the constant velocity linear beam; and
vertically reflecting the beam to form a dotted image on a surface of a photoconductive medium.

34. The method of claim 33, further comprising:
compensating for a spherical aberration before polarizing the constant velocity linear beam.

35. The method of claim 33, wherein the polarizing of the constant velocity linear beam comprises polarizing the beam to the vertical scanning direction by a predetermined refractive index.
